(19) United States
(12) Patent Application Publication
(10) Pub. No.: US 2010/0196848 A1
(43) Pub. Date: Aug. 5, 2010

(54) Dentistry Isolator

(76) Inventors: Fãbio Luis Camargo Villeia Berbert, Araraquara/sp (BR); Maarta Gimenez Zem Berbert, Araraquara/sp (BR)

Correspondence Address: JOHN ALEXANDER GALBREATH, 2516 CHESTNUT WOODS CT, REISTERSTOWN, MD, 21136, US

(21) Appl. No.: 12/443,539

(22) PCT Filed: Oct. 4, 2007
(86) PCT No.: PCT/BR07/00268

§ 371 Date: Mar. 30, 2009

(30) Foreign Application Priority Data
Oct. 4, 2006 (BR) PI0605288-6

(51) Int. Cl. A61C 5/14

(52) U.S. Cl. 433/136

(57) ABSTRACT

It is related to an operatory field barrier used in Dentistry, consisting of a rubber dam with a special design simulating either the left or the right side of the oral environment so that it can be used in both sides of the patients' mouth including their superior and inferior teeth (dental arch), their antagonists up to the canines or pre-molars from the opposite side having along their oclusal surfaces convexities related to the dental crowns of that teeth as well as the partial and total reproductions of their bucal sulcus (superior and inferior), the lingual sulcus (inferior) and or the palate (superior) respectively. The product contains borders that will always be outside the mouth completing its elliptical or square or rectangular shape a little bit bigger that the open mouth and these limits have a thicker rubber as an alternative instead of using the conventional frame. The invention consists of a structure made of a rubber material a little bit thicker, beyond 1 mm extending all over the deeper reproduction area of the palate, the lingual sulcus and also the bucal sulcus (superior and inferior) up to their gathering in the distal side of the molars and in the distal side of the canines or pre-molars from the opposite side. This thicker rubber material shouldn't have the width inferior to 2 mm.

This invention is related to an operatory field isolation used in Dentistry, consisting of a rubber dam with a special design simulating either the left or the right side of the oral environment so that it can be used in both sides of the patients' mouth including their superior and inferior teeth (dental arches) antagonists up to the canines or pre-molars from the opposite side having along their oclusal surface convexities, related to the dental crowns of that teeth as well as the partial and total reproductions of their bucal sulcus (superior and inferior), the lingual sulcus (inferior) and or the palate (superior) respectively. The product contains borders that will always be outside the mouth completing its elliptical or square or rectangular shape a little bit bigger that the open mouth and these limits have a thicker rubber as an alternative instead of using the conventional frame. The invention consists of a structure made of a rubber material a little bit thicker, beyond 1 mm extending all over the deeper reproduction area of the palate, the lingual sulcus and also the bucal sulcus (superior and inferior) up to their gathering in the distal side of the molars and in the distal side of the canines from the opposite side. This thicker rubber material shouldn't have the width inferior to 1 mm. This invention claimed eliminates the extension pressure or the rubber dam be extend and much inconvenient caused by the conventional rubber dam, considering that extend to reach the tooth inside the patient's mouth is not necessary. This invention has a shape that will make easier the X-Ray set up upon the rubber dam, without the need of its partial or total removal, different from what happens when the conventional rubber dam is used.

As the invention simulates the teeth of the semi-arches (superior and inferior) up to the canines and pre-molars from the opposite side letting the other side of the patient's oral environment free from any object close to his throat, this invention will avoid that the patient chokes.

In each, superior or inferior dental semi arch projection or reproduction, there are also partial and round reproductions of each dental crown. This reproduction will completely eliminate any rubber dam's tension of extend, but that one, made on the hole with the purpose of holding the dental crown, avoiding the saliva penetration to the isolated field.

This invention will allow the dentists and mainly the endodontologists making the total barrier of the operatory field in a simple and easy way, saving the time required to its preparatory once it is a procedure that takes too much time during each treatment's appointment. Another inconvenient of using the conventional frame happens when it looses itself from the barrier during the therapy breaking the asseptical chain putting the patient, dentist and assistant's health in risk. This new system eliminates any pressure upon the rubber dam making very difficult the possibility of tearing it or moving the metal clamps, what is very common in conventional techniques.

Something that the professional has to take into account is that when the tooth is submitted to the endodontic therapy the crown is usually destroyed and when it is submitted to the metal clamp force, the crown frequently breaks, causing the tooth's extraction. This new invention makes metal clamps something useless in the majority of cases.

Another great advantage of this system is the possibility of taking the X-Ray without the need of removing partially or totally the isolation, avoiding other inconvenient like the contamination of the dentist and assistant's gloves and the X-Ray film caused by the patient's saliva and its consequences.

As its removal is not necessary, taking the X-Ray will be an easier task and the professional will make less mistakes considering that the film will be positioned getting the tooth's direct sight, using it as the reference point.

As the metal clamps are rarely used, the incidence of their superposition on the required structure on the X-Ray film will not happen anymore.

As in this rubber dam there is the simulation of the dental semi arch (superior and inferior) up to the canines or pre-molars from the opposite side letting the other side of the patient's oral environment free from any object close to his throat, this invention will avoid that the patient chokes.

In each superior or inferior dental hemi arch projection or reproduction, there are also partial and round reproductions of each dental crown (convexities). This reproduction will completely eliminate any rubber dam's tension of extend, but that one made on the hole with the purpose of holding the dental crown, avoiding the saliva penetration to the isolated field (picture 5 and 6).

The invention consists of a structure made of a rubber material a little bit thicker, beyond 1 mm extending all over the deeper reproduction area of the palate, the lingual sulcus and also the bucal sulcus (superior and inferior) up to their gathering in the distal side of the molars and in the distal side of the canines from the opposite side. This thicker rubber material shouldn't have the width inferior to 1 mm.

On the region out of the mouth, nearby the lips, the external limits or borders consist equally of a thicker rubber material, adapting perfectly to the patient's face, substituting the conventional frame, which is necessary to keep the rubber dam positioned on his face, eliminating this frame additional cost and other inconvenient felt by the patient because of the frame orders and the conventional rubber dam, what so many times damage the patient's breath and eyes.

### STATE OF THE ART

Nowadays to make an absolute isolation, the clinicians use a simple flat rubber dam, with dimensions over 10.0×10.0 cm, very fine and elastic, having its edges or lateral limits tight by a plastic frame, keeping it extended and with its extremities out of the patient's mouth, when the central part of it was put in contact with the tooth. In order to do it, we should perforate it using its own tool, so that the crown of the tooth to be isolated transposes and be hold by the borders of this short hole having 0.4 to 0.2 mm of diameter dilated on elastic extend up to a diameter five times bigger, in order to let such covering. When the crown of the tooth will be hold up to the gengival or cervical crest, we should put a metal clamp over the rubber dam also close to the cervical area of the tooth. This metal clamp is open under pressure and taken in position using a clamp rack, letting the metal clamps in its proper place when removed, the metal clamp makes strong pressure on the retentive area of the dental cervical part, keeping the whole tight. The problem now is related to the rubber dam, extended at last, mainly when the procedure is done in posterior teeth, so that the rubber tears, letting the saliva penetration over the dental crown again or at least getting all the time during the therapy as it was a “trap” or “sling” ready to be thrown toward the dentist or assistant and that is the reason why safety glasses should be used.

In order to solve these problems, some attempts were created with the purpose of eliminating this tension of extension suffered by the rubber dam.

Some devices did not have the flat rubber shape, to get the shape of a big condom, which during the isolation procedure was projected inside the mouth, using a system of frames which belong to the kit.

The inconvenient thing of this system of isolation is the possibility of the patient's choking with all those stuff put close to his throat.

Another significant reason is that these new devices did not eliminate completely the problem of adaptation and extension of the rubber and its consequences.

Another problem faced not only with the conventional rubber dam but also with these devices recently developed is the need of removing the frame and the rubber dam partially or totally, so that the professional can take the X-Ray film under the isolation and in contact with the buccal fluid, like saliva, contaminating the film, the dentist and assistant's gloves and consequently spreading contamination in everything they can touch.

So, the reasons taken into account to create the product were the difficulties in reaching a suitable dominion of the asseptical chain using a stable absolute isolation that allow the X-Ray set up without breaking the asseptical chain and do not offer any risk of the patient's choke or damage the patient's nose or eyes because of the frame or cause any breathing difficulties because of the rubber dam, having the following functional and technical advantages:
It is easy of dealing with;
An assistant is not required;
X-Ray easily set up with less mistakes and repeated X-Ray exposure;
The dentist and patient will fell comfortable;
Less X-Ray exposure;
Less stress with the isolation's tearing;
Fewer appointments and more chances of success;
Less chances of causing gengival trauma and post-operatory pain determined by metal clamps;

Less risk to the operator:
of contamination;
of the metal clamp impact on his face;

Less risk to the patient:
Contamination of the tooth;
Gengival inflammation determined by the metal clamp;
Excessive exposure of X-Ray;
Damage of the nose and eyes of the patient caused by the frame;
Less risk of the patient's choking;

Economical benefits:
The professional does not use so many grampos, so the need of replacing it is rare;
The dentist will save the use of rubber dam;
Less X-Ray repetition (film's cost);
The dentist will work in a smaller period of time.

### DETAILED DESCRIPTION OF THE FIGURES

In order to have a better understanding of this invention, we will send some illustrative pictures, containing the constructive details, application and particularities of the device.

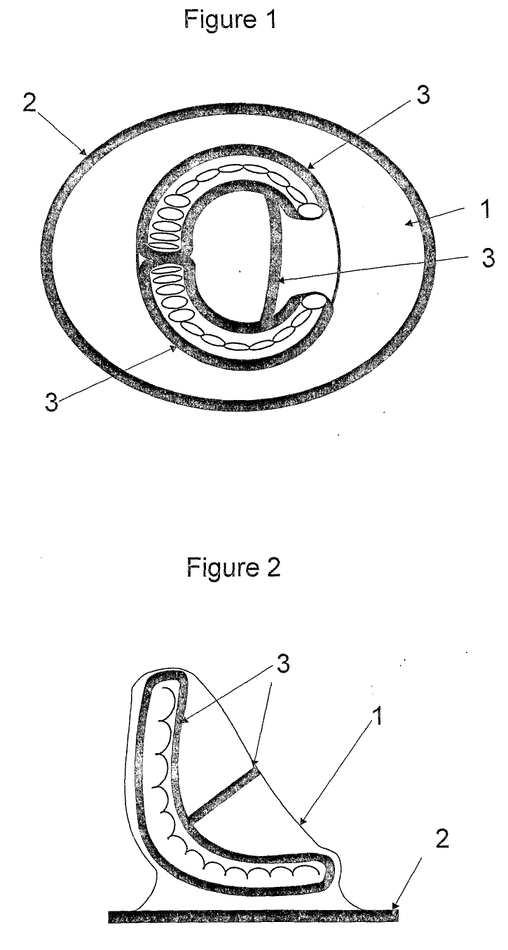

The FIGS. 1 and 2 show the invention, respectively, in frontal and superior view, allowing the observation of the mouth in one of its sides (right and left), so that the use of the isolator is possible (1) not only on the left but also on the right side of the patient's mouth, with his dental arches, superior and inferior, antagonists up to the canines or pre-molars from the opposite side having along their oclusal surface convexities, related to the dental crowns of that teeth as well as the partial and total reproductions of their bucal sulcus (superior and inferior), the lingual sulcus (inferior) and or the palate (superior) respectively. It can also be observed, yet, the border or limits (2) that will always be out of the mouth and that complete its elliptical or square or rectangular shape a little bit bigger than an open mouth and these limits have a rubber thicker as the substitution of a conventional frame, like the structure (3) made of a rubber material, beyond 1 mm, extending from the palate and lingual floor, as the vestibule floor up to their gathering in the distal side of the molars and in the distal side of the canines from the opposite side.

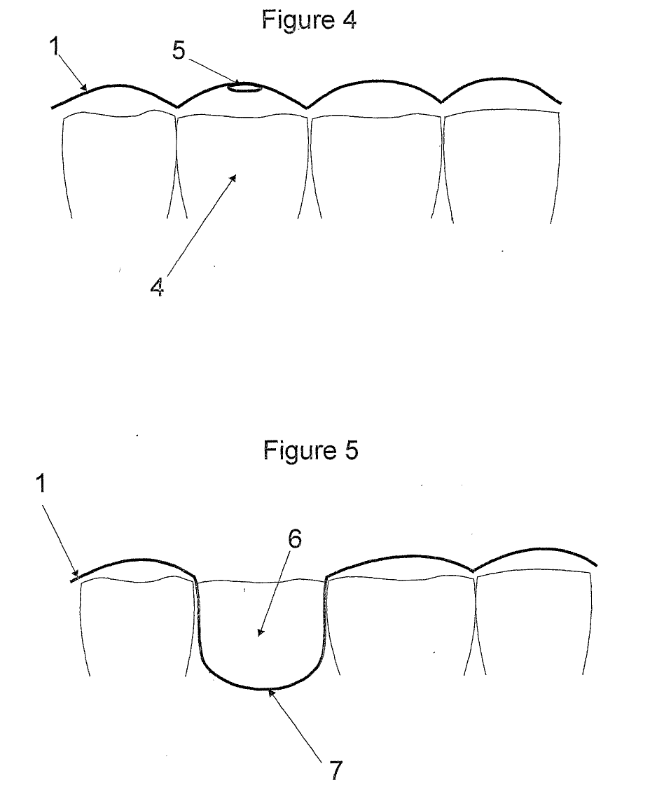

The FIGS. 3 and 4 show an isolation operatory example, being observed the isolator (1), the crown to be isolated (4), perforation before holding and isolating the crown (5), the crown properly isolated (6) and the perforation (7) enlarged hold under the extension pressure having the isolated tooth as the basis.

1-) DENTISTRY ISOLATOR, characterized by a rubber dam with a special design simulating either the left or the right side of the oral environment so that it can be used in both sides of the patients' mouth including their superior and inferior teeth (dental arches), their antagonists up to the canines or pre-molars from the opposite side having along their oclusal surfaces convexities related to the dental crowns of that teeth as well as the partial and total reproductions of their bucal sulcus (superior and inferior), the lingual sulcus (inferior) and or the palate (superior) respectively; the product contains borders that will always be outside the mouth completing its elliptical or square or rectangular shape a little bit bigger that the open mouth and these limits have a thicker rubber as an alternative instead of using the conventional frame; the product consists of a structure made of a rubber material a little bit thicker, beyond 1 mm extending all over the deeper reproduction area of the palate, the lingual sulcus and also the bucal sulcus (superior and inferior) up to their gathering in the distal side of the molars and in the distal side of the canines or pre-molars from the opposite side.
